(19) United States
(12) Patent Application Publication
(10) Pub. No.: US 2022/0345322 A1
(43) Pub. Date: Oct. 27, 2022

(54) RESEARCH MANAGING SERVER FOR PERFORMING REALTIME RESEARCH INTERWORKING MULTIPLE NODE UNITS WHICH CONSTITUTE BLOCKCHAIN NETWORK AND THE OPERATING METHOD THEREOF

(71) Applicant: Giunwoo LEE, Seoul (KR)

(72) Inventors: Giunwoo LEE, Seoul (KR); Dongkyu JUNG, Goyang-si, Gyeonggi-do (KR)

(73) Assignee: Giunwoo LEE, Seoul (KR)

(21) Appl. No.: 17/422,746

(22) PCT Filed: May 27, 2021
(86) PCT No.: PCT/KR2021/006628

§ 371 Date: Jul. 14, 2021

(30) Foreign Application Priority Data
Aug. 21, 2020 (KR) 10-2020-0105101

(51) Int. Cl. H04L 9/00; H04L 9/32; G06Q 10/06

(52) U.S. Cl. CPC H04L 9/50; H04L 9/3239; G06Q 10/063

(57) ABSTRACT

Disclosed is a research managing server for performing a realtime research interworking multiple node units which constitute a blockchain network, and the operating method thereof. The present invention presents a research managing server which selects research subject members according to a criterion desired by a manager among multiple members based on gender, age, and residence of multiple members registered in a blockchain network, performs an authentication for the research subject members, transmits question information for a research to terminals of the research subject members, and then receives answer information for the question information from the terminals of the research subject members and transmits the received answer information to a terminal of the manager, and the operating method thereof to support the manager to quickly obtain a research result.

### TECHNICAL FIELD

The present invention relates to a research managing server for performing a realtime research interworking multiple node units which constitute a blockchain network and the operating method thereof.

### BACKGROUND ART

Recently, a need for research on people around the world has been increasingly expanding. For example, when a company should consider responses of a variety of customer layers around the world when making a decision, there are many cases of performing the research for customer layers around the world in order to collect data required for decision making.

In this regard, in order to obtain a desired result through the research, it is necessary to select a research subject according to a criterion desired by a manager that intends to perform the research. However, from a realistic point of view, it is difficult for the manager to autonomously select the research subject which conforms to the desired criterion for the customer layers around the words and perform the research.

In the related art, in working on the research, since a lot of time is required to select the research subject, it is difficult to work on the research in real time. As a result, even in a situation in which the decision making should be quickly performed based on a predetermined research result, a lot of time is required for the research, so there is a problem in that the decision making is delayed.

In this regard, introduction of a research system may be considered, in which after subjects who intend to participate in the research are previously secured as members, when a quick research is required later, the research is performed for the members to support a research result to be obtained in real time. In this case, a predetermined compensation is performed for the members who participate in the research to guide an active participation in the research.

In general, in working on the research, there are many cases in which personal information including gender, age, residence, etc., of subjects who participate in the research is required. The reason is that only when the personal information should be known, statistics for the research result can be written. For example, when a preference for a product is examined, only by classifying a preference examination result according to the gender, age, and residence of the research subjects, if a new product is developed later, an appropriate function according to a layer targeted by the product will be able to be included.

Accordingly, when the above-mentioned research system is introduced, the corresponding research system should secure personal information such as accurate gender, age, residence, etc., of each member. That is, it is necessary to guarantee the integrity for the personal information of each member.

In this regard, in recent years, as a blockchain technology which dispersedly stores predetermined data in multiple node units other than a central server to guarantee the integrity for the corresponding data has appeared, a method may be considered in which even the research system manages the personal information of each member through a blockchain network to secure the reliability for the personal information of the members who participate in the research.

Therefore, a research into a research system technology is required, which interworks node units on a blockchain network storing blockchain data constituted by personal information such as gender, age, and residence of predetermined members to enable a realtime research for the members.

Further, in that the research system needs to verify whether members who participate in the research matches an authentic member which registers personal information thereof on the blockchain network, a technology for performing user authentication for the members who participate in the research also needs to be introduced.

### DISCLOSURE

### Technical Problem

The present invention presents a research managing server and the operating method thereof, which select research subject members according to a criterion desired by a manager among multiple members based on gender, age, and residence of multiple members registered in a blockchain network, perform an authentication for the research subject members, transmit question information for a research to terminals of the research subject members, and then receive answer information for the question information from the terminals of the research subject members and transmit the received answer information to a terminal of the manager to support the manager to quickly obtain a research result.

### Technical Solution

According to an embodiment of the present invention, a research managing server performing a realtime research interworking multiple node units (each of the plurality of node units stores blockchain data having information on gender, age, and residence of a plurality of members, and terminal identification information for a terminal possessed by each of the plurality of members recorded therein) constituting a blockchain network includes: when information on multiple questions for the research and criterion information constituted by gender, age, and residence for selecting a research subject member is received from a terminal of the manager, an information request unit requesting extracting terminal identification information for a terminal of a member having information on gender, age, and residence matching the criterion information among the multiple members from the blockchain data and transmitting the terminal identification information by accessing a first node unit which is any one node unit of multiple node units, to the first node unit; as the first node unit extracts terminal identification information for terminals of at least one first member of the multiple members from the blockchain data, when the terminal identification information for the terminal of at least one first member is received from the first node unit, an authentication performing unit performing a user authentication for the at least one first member by accessing the terminal of at least one first member based on the terminal identification information for the terminals of at least one first member; when the user authentication for the at least one first member is completed, an answer request unit transmitting information on the plurality of questions to the terminal of at least one first member and requesting the terminal of at least one first member to transmit answer information for the plurality of questions; and an answer transmission unit receiving the answer information for the plurality of questions from the terminal of the at least one first member and transmitting the answer information for the plurality of questions received from the terminal of the at least one first member to the terminal of the manager.

Further, according to an embodiment of the present invention, an operation method of a research managing server performing a realtime research interworking multiple node units (each of the plurality of node units stores blockchain data having information on gender, age, and residence of a plurality of members, and terminal identification information for a terminal possessed by each of the plurality of members recorded therein) constituting a blockchain network includes: when information on multiple questions for the research and criterion information constituted by gender, age, and residence for selecting a research subject member are received from a terminal of the manager, requesting extracting terminal identification information for a terminal of a member having information on gender, age, and residence matching the criterion information among the multiple members from the blockchain data and transmitting the terminal identification information by accessing a first node unit which is any one node unit of multiple node units, to the first node unit; as the first node unit extracts terminal identification information for terminals of at least one first member of the multiple members from the blockchain data, when the terminal identification information for the terminal of at least one first member is received from the first node unit, performing a user authentication for the at least one first member by accessing the terminal of at least one first member based on the terminal identification information for the terminals of at least one first member; when the user authentication for the at least one first member is completed, transmitting information on the plurality of questions to the terminal of at least one first member and requesting the terminal of at least one first member to transmit answer information for the plurality of questions; and receiving the answer information for the plurality of questions from the terminal of the at least one first member and transmitting the answer information for the plurality of questions received from the terminal of the at least one first member to the terminal of the manager.

### Advantageous Effects

The present invention presents a research managing server and the operating method thereof, which select research subject members according to a criterion desired by a manager among multiple members based on gender, age, and residence of multiple members registered in a blockchain network, perform an authentication for the research subject members, transmit question information for a research to terminals of the research subject members, and then receive answer information for the question information from the terminals of the research subject members and transmit the received answer information to a terminal of the manager to support the manager to quickly obtain a research result.

### DESCRIPTION OF DRAWINGS

FIG. 1 is a diagram illustrating a structure of a research managing server performing a realtime research according to an embodiment of the present invention.

FIG. 2 is a flowchart showing an operating method of a research managing server performing a realtime research according to an embodiment of the present invention.

### MODE FOR INVENTION

Hereinafter, embodiments of the present invention will be described in detail with reference to the accompanying drawings. The description does not limit the present invention to specific embodiments, and it should be understood that the present invention covers all the modifications, equivalents and replacements included within the idea and technical scope of the present invention. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising”, will be understood to imply the inclusion of stated elements but not the exclusion of any other elements. Further, in various embodiments of the present invention, each of components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning compute program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

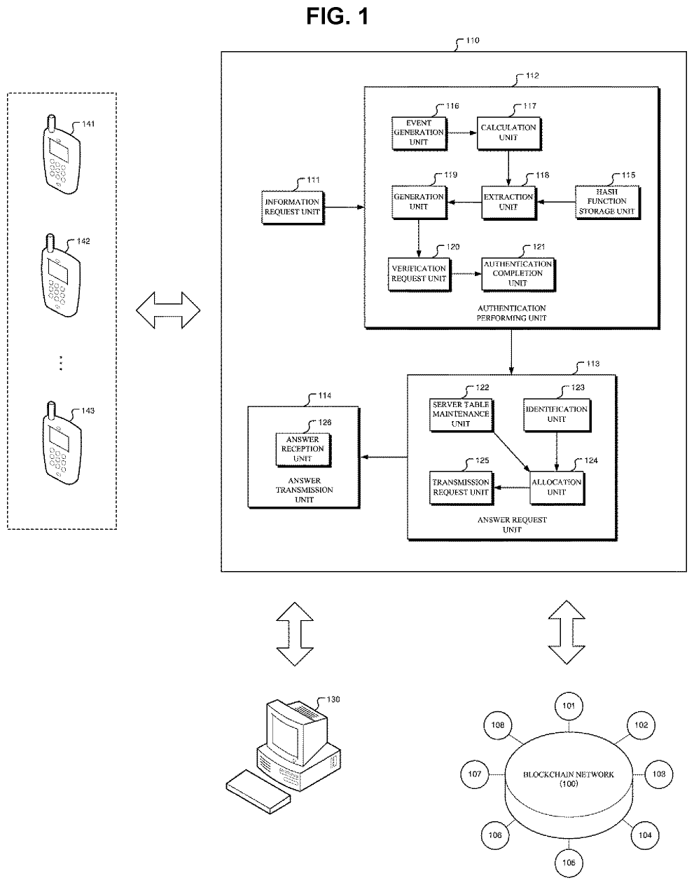

FIG. 1 is a diagram illustrating a structure a research managing server performing a realtime research according to an embodiment of the present invention.

A research managing server 110 performing a realtime research according to the present invention as a research managing server performing the realtime research interworking multiple node units 101, 102, 103, 104, 105, 106, 107, and 108 constituting a blockchain network 100 includes an information request unit 111, an authentication performing unit 112, an answer request unit 113, and an answer transmission unit 114.

First, each of the multiple node units 101, 102, 103, 104, 105, 106, 107, and 108 stores blockchain data having information on gender, age, and residence of multiple members and terminal identification information for a terminal held by each of the multiple members recorded therein. Here, the terminal identification information is identification information granted to each terminal in advance to distinguish different terminals, and a MAC address or an International Mobile Equipment Identity (IMEI) may be used as the terminal identification information.

For example, each of the multiple node units 101, 102, 103, 104, 105, 106, 107, and 108 stores blockchain data having information on gender, age, and residence of multiple members and terminal identification information for a terminal held by each of the multiple members recorded therein as shown in Table 1 below.

TABLE 1

| | | | | Terminal identification |
|---|---|---|---|---|
| | | | | information |
| Multiple | | | | for terminal held by each |
| members | Gender | Age | Residence | of multiple members |
| Member 1 | Female | 29 years old | Seoul | Terminal identification |
| | | | | information 1 |
| Member 2 | Female | 22 years old | Tokyo | Terminal identification |
| | | | | information 2 |
| Member 3 | Female | 26 years old | Beijing | Terminal identification |
| | | | | information 3 |
| Member 4 | Male | 33 years old | Paris | Terminal identification |
| | | | | information 4 |
| Member 5 | Male | 37 years old | New York | Terminal identification |
| | | | | information 5 |
| . . . | . . . | . . . | . . . | . . . |

When the information request unit 111 receives information on multiple questions for the research and criterion information constituted by gender, age, and residence for selecting a research subject member from a terminal 130 of the manager, the information request unit 111 requests extracting terminal identification information for a terminal of a member having information on gender, age, and residence matching the criterion information among the multiple members from the blockchain data and transmitting the terminal identification information to a first node unit 101 by accessing the first node unit 101 which is any one node unit of multiple node units 101, 102, 103, 104, 105, 106, 107, and 108.

As the first node unit 101 extracts terminal identification information for terminals 141, 142, and 143 of at least one first member of the multiple members from the blockchain data, when the authentication performing unit 112 receives the terminal identification information for the terminals 141, 142, and 143 of at least one first member from the first node unit 101, the authentication performing unit 112 performs a user authentication for the at least one first member by accessing the terminals 141, 142, and 143 of at least one first member based on the terminal identification information for the terminals 141, 142, and 143 of at least one first member.

For example, when it is assumed that the information request unit 111 receives ‘female, 20 years old, and Northeast Asia’ as the information on multiple questions for the research and the criterion information for selecting the research subject member from the terminal 130 of the manager, the information request unit 111 may request extracting terminal identification information for a terminal of a member having information on gender, age, and residence matching the criterion information among the multiple members from the blockchain data and transmitting the terminal identification information to the first node unit 101 by accessing the first node unit 101 which is any one node unit of multiple node units 101, 102, 103, 104, 105, 106, 107, and 108.

In this case, since a member having information on gender, age, and residence corresponding to ‘female, 20 years old, and Northeast Asia’ among multiple members is recorded to be ‘member 1, member 2, and member 3 in the block chain data recorded as in Table 1 above, the first node unit 101 may extract ‘terminal identification information 1, terminal identification information 2, and terminal identification information 3’ which are terminal identification information for the terminals 141, 142, and 143 of ‘member 1, member 2, and member 3’ from the blockchain data as the terminal identification information for the terminals 141, 142, and 143 of at least one first member, and transmit ‘terminal identification information 1, terminal identification information 2, and terminal identification information 3’ to the research managing server 110.

As a result, when ‘terminal identification information 1, terminal identification information 2, and terminal identification information 3’ are received from the first node unit 101 to the research managing server 110, the authentication performing unit 112 may perform the user authentication for ‘member 1, member 2, and member 3’, by accessing the terminals 141, 142, and 143 of ‘member 1, member 2, and member 3’ based on ‘terminal identification information 1, terminal identification information 2, and terminal identification information 3’.

In this case, according to an embodiment of the present invention, the authentication performing unit 112 may include a hash function storage unit 115, an event generation unit 116, a calculation unit 117, an extraction unit 118, a generation unit 119, a verification request unit 120, and an authentication completion unit 121.

First, the hash function storage unit 115 stores n (n is a natural number of 2 or more) hash functions which are previously shared with the terminals of the multiple members. Here, different integer values of 0 or more and n−1 or less are allocated to the n hash functions, respectively.

For example, when n is 5, the hash function storage unit 115 may store 5 hash functions as in Table 2 below.

TABLE 2

| 5 hash functions | Integer value |
|---|---|
| Hash function 1 | 0 |
| Hash function 2 | 1 |
| Hash function 3 | 2 |
| Hash function 4 | 3 |
| Hash function 5 | 4 |

When the event generation unit 116 receives the terminal identification information for the terminals 141, 142, and 143 of at least one first member from the first node unit 101, the event generation unit 116 generates an authentication event for performing the user authentication for at least one first member after accessing the terminals 141, 142, and 143 of at least one first member based on the terminal identification information for the terminals 141, 142, and 143 of at least one first member.

When the authentication event is generated, the calculation unit 117 performs a modulo operation having n as a divisor for a date value at a current time where the authentication event is generated to calculate a first operation value.

Here, the modulo operation means an operation that performs a division of dividing a dividend by the divisor to calculate a remainder therefor.

For example, when n is 5 as in the above-described example, and a date of the current time when the authentication event is generated by the event generation unit 116 is ‘August 13, 2020’, the calculation unit 117 performs the modulo operation having 5 as the divisor for ‘20200813’ to calculate 3 as a first operation value.

When the first operation value is calculated by the calculation unit 117, the extraction unit 118 extracts a first hash function in which the first operation value is allocated as an integer value among then hash functions from the hash function storage unit 115.

The generation unit 119 applies each terminal identification information for the terminals 141, 142, and 143 of at least one first member to the first hash function as an input of the first hash function to generate a hash value corresponding to the at least one first member, respectively.

When the hash function corresponding to the at least one first member, respectively is generated, the verification request unit 120 transmits the hash value corresponding to each member to each of the terminals 141, 142, and 143 of at least one first member, and transmits a verification request for the hash value.

For example, as in the above-described example, when n is 5 and when 3 is calculated as the first operation value by the calculation unit 117, the extraction unit 118 may extract a first hash function in which 3 is allocated as the integer value among 5 hash functions from the hash function storage unit 115. In this regard, since the hash function storage unit 115 storing 5 hash functions stores that the hash function in which 3 is allocated as the integer value is ‘hash function 4’ as shown in Table 2 above, the extraction unit 118 may extract ‘hash function 4’ as the first hash function from the hash function storage unit 115.

When the extraction unit 118 extracts ‘hash function 4’ as the first hash function from the hash function storage unit 115 as such, the generation unit 119 may generate hash values corresponding to ‘member 1, member 2, and member 3’ like ‘hash value 1, hash value 2, and hash value 3’ by applying ‘terminal identification information 1, terminal identification information 2, and terminal identification information 3’ which are the terminal identification information for the terminals 141, 142, and 143 of at least one first member to ‘hash function 4’ as an input.

Then, the verification request unit 120 may transmit ‘hash value 1’ to the terminal 141 of ‘member 1’ and transmit a verification request for ‘hash value 1’, transmit ‘hash value 2’ to the terminal 142 of ‘member 2’ and transmit a verification request for ‘hash value 2’, and transmit ‘hash value 3’ to the terminal 143 of ‘member 3’ and transmit a verification request for ‘hash value 3’.

In this case, according to an embodiment of the present invention, each of the terminals 141, 142, and 143 of at least one first member may prestore the n hash functions on the memory.

Further, when each of the terminals 141, 142, and 143 of at least one first member receives the hash value corresponding to each member and the verification request from the research managing server 110, each terminal may calculate the first operation value by performing the modulo operation having n as the divisor for the date value of the current time when the hash value is received.

Then, each of the terminals 141, 142, and 143 of at least one first member selects the first hash function in which the first operation value is allocated as the integer value among the n hash functions, and then applies the terminal identification information for the terminals 141, 142, and 143 of each member to the first hash function as an input to generate a verification hash value.

Thereafter, when it is identified that the verification hash value matches the hash value, each of the terminals 141, 142, and 143 of at least one first member may generate the verification completion message and transmit the generated verification completion message to the research managing server 110.

For example, as in the above-described example, it is assumed that n is 5, and each of the terminals 141, 142, and 143 of ‘member 1, member 2, and member 3’ which are the at least one first member prestores 5 hash functions shown in Table 2 above.

In this case, when a date of the current time when the verification request is received from the research managing server 110 together with ‘hash value 1’ is ‘August 13, 2020’, for the terminal 141 of ‘member 1’, the member 141 of ‘member 1’ performs a modulo operation having 5 as the divisor for ‘20200813’ which is the date value of the current time when the ‘hash value 1’ is received to calculate the first operation value as 3.

In this case, since the hash function storage unit 115 storing 5 hash functions stores that the hash function in which 3 is allocated as the integer value is ‘hash function 4’ as shown in Table 2 above, the terminal 141 of ‘member 1’ may select ‘hash function 4’ in which 3 is allocated as the integer value among the 5 hash functions as the first hash function.

Then, the terminal 141 of ‘member 1’ applies ‘terminal identification information 1’ which is the terminal identification information for ‘member 1’ to ‘hash function 4’ as the input to generate the verification hash value.

When the verification hash value is generated, if the terminal 141 of ‘member 1’ compares the verification hash value and the ‘hash value 1’ received from the research managing server 110 and identifies that the verification hash value matches the ‘hash value 1’, the terminal 141 of ‘member 1’ may generate a verification completion message indicating that verification for the ‘hash value’ is completed and transmit the generated verification completion message to the research managing server 110.

By such a scheme, the terminals 141, 142, and 143 of ‘member 1, member 2, and member 3 verify ‘hash value 1, hash value 2, and hash value 3’, respectively, and when verifying each hash value is completed, the terminals 141, 142, and 143 may generated the verification completion message and transmit the generated verification completion message to the research managing server 110.

As the verification for the hash value is completed in response to the verification request in the terminals 141, 142, and 143 of at least one first member, when the verification completion message for the hash value is received from the terminals 141, 142, and 143 of at least one first member, the authentication completion unit 121 may process completion of the user authentication for the at least one first member.

In this case, since the authentication completion unit 121 may not determine that the user is one of the plurality of members with respect to a user of a terminal of a member which may not generate the verification completion message because it is not identified that the verification hash value and the hash value match each other among the terminals 141, 142, and 143 of at least one first member, the authentication completion unit 121 does not complete the user authentication.

When the user authentication for the at least one first member is completed through the authentication performing unit 112, by such a scheme, the answer request unit 113 transmits information on the plurality of questions to the terminals 141, 142, and 143 of at least one first member and requests the terminals 141, 142, and 143 of at least one first member to transmit answer information for the plurality of questions.

In this case, the terminals 141, 142, and 143 of at least one first member receive the answer information for the plurality of questions from the users of the terminals 141, 142, and 143 of each member, and then transmit the received answer information to the research managing server 110 and in this case, the answer transmission unit 114 receives the answer information for the plurality of questions from the terminals 141, 142, and 143 of at least one first member and transmits the answer information for the plurality of questions received from the terminals 141, 142, and 143 of at least one first member to the terminal 130 of the manager.

Consequently, the research managing server 110 according to the present invention selects research subject members according to a criterion desired by a manager among multiple members based on gender, age, and residence of multiple members registered in a blockchain network, performs an authentication for the research subject members, transmits question information for a research to terminals of the research subject members, and then receives answer information for the question information from the terminals of the research subject members and transmits the received answer information to a terminal of the manager to support the manager to quickly obtain a research result.

In this case, according to an embodiment of the present invention, the answer request unit 113 may include a server table maintenance unit 122, an identification unit 123, an allocation unit 124, and a transmission request unit 125.

The server table maintenance unit 122 stores and maintains a server table having server identification information for each of a plurality of relay servers and predetermined regional information corresponding to each of the plurality of relay servers recorded therein.

For example, when there are 5 relay servers, the server table maintenance unit 122 may store and maintain a server table having server identification information for the 5 relay servers and predetermined regional information corresponding to each of the 5 relay servers recorded therein as shown in Table 3 below.

TABLE 3

| | Server identification | |
|---|---|---|
| Multiple relay servers | information | Regional information |
| Relay server 1 | Server identification | Korea, Japan |
| | information 1 | |
| Relay server 2 | Server identification | China |
| | information 2 | |
| Relay server 3 | Server identification | Americas |
| | information 3 | |
| Relay server 4 | Server identification | Europe |
| | information 4 | |
| Relay server 5 | Server identification | Southeast Asia |
| | information 5 | |

When the user authentication for the at least one first member is completed, the identification unit 123 identifies a network access region accessed by each of the terminals 141, 142, and 143 of at least one first member.

The allocation unit 124 allocates a relay server having regional information corresponding to network access regions accessed by the terminals 141, 142, and 143 of each member to each of the terminals 141, 142, and 143 of at least one first member one by one by referring to the server table.

When the relay server is allocated to each of the terminals 141, 142, and 143 of at least one first member, the transmission request unit 125 transmits the information on the plurality of questions and the server identification information for the relay server allocated to the terminals 141, 142, and 143 of each member to the terminals 141, 142, and 143 of at least one first member and requests the terminals 141, 142, and 143 of at least one first member to transmit the answer information for the plurality of questions through the relay servers allocated to the terminals 141, 142, and 143 of each member.

In this case, according to an embodiment of the present invention, when the answer information for the plurality of questions is input by the users of the terminals 141, 142, and 143 of each member after the information on the plurality of questions is received from the research managing server 110, each of the terminals 141, 142, and 143 of at least one first member may transmit the answer information for the plurality of questions to the research managing server 110 through the relay servers allocated to the terminals 141, 142, and 143 of each member among the plurality of relay servers based on the server identification information of the relay servers allocated to the terminals 141, 142, and 143 of each member, which is received from the research managing server 110.

In this case, the answer transmission unit 114 may include an answer reception unit 126 that receives the answer information for the plurality of questions transmitted from the terminals 141, 142, and 143 of at least one first member through the relay servers allocated to the terminals 141, 142, and 143 of at least one first member, respectively among the plurality of relay servers.

Hereinafter, operations of the identification unit 123, the allocation unit 124, the transmission request unit 125, the terminals 141, 142, and 143 of at least one first member, and the answer reception unit 126 will be described in detail as an example.

First, as in the above-described example, it is assumed that the user authentication of ‘member 1, member 2, and member 3’ as the at least one first member is completed. In this case, the identification unit 123 may identify the network access region accessed by each of the terminals 141, 142, and 143 of ‘member 1, member 2, and member 3’.

When the identification unit identifies that the network access regions accessed by the terminals 141, 142, and 143 of ‘member 1, member 2, and member 3’, respectively are ‘Seoul, Tokyo, and Beijing’, the allocation unit 124 may allocate relay servers having regional information corresponding to ‘Seoul, Tokyo, and Beijing’ to the terminals 141, 142, and 143 of ‘member 1, member 2, and member 3’, respectively by referring to the server table. In this regard, since the regional information corresponding to ‘Seoul and Tokyo’ is ‘Korea and Japan’, and the regional information corresponding to ‘Beijing’ is ‘China’, and the relay servers having the regional information corresponding to ‘Korea and Japan’ are recorded as ‘relay server 1’ and the relay server having the regional information corresponding to ‘China’ is recorded as ‘relay server 2’ in the server table recorded as shown in Table 3 above, the allocation unit 124 may allocate ‘relay server 1’ to each of the terminals 141 and 142 of ‘member 1 and member 2’ and allocate ‘relay server 2’ to the terminal 143 of ‘member 3’.

Then, the transmission request unit 125 may transmit the information on the plurality of questions and ‘server identification information 1’ which is the server identification information for ‘relay server 1’ to the terminals 141 and 142 of ‘member 1 and member 2’ and request the terminals 141 and 142 of ‘member 1 and member 2’ to transmit the answer information for the plurality of questions through ‘relay server 1’, and transmit the information on the plurality of questions and ‘server identification information 2’ which is the server identification information for ‘relay server 2’ to the terminal 143 of ‘member 3’, and request the terminal 143 of ‘member 3’ to transmit the answer information for the plurality of questions through ‘relay server 2’.

Thereafter, when the users of the terminals 141, 142, and 143 of each member input the answer information for the plurality of questions into the terminals 141, 142, and 143 of each member, each of the terminals 141 and 142 of ‘member 1 and member 2’ may transmit the answer information for the plurality of questions to the research managing server 110 through ‘relay server 1’ among the plurality of relay servers based on ‘server identification information 1’ received from the research managing server 110, and the terminal 143 of ‘member 3 may transmit the answer information for the plurality of questions to the research managing server 110 through ‘relay server 2’ among the plurality of relay servers based on ‘server identification information 2’ received from the research managing server 110.

In this case, the answer reception unit 126 may receive the answer information for the plurality of questions transmitted from the terminals 141 and 142 of ‘member 1 and member 2’ through ‘relay server 1’ among the plurality of relay servers, and receive the answer information for the plurality of questions transmitted from the terminal 143 of ‘member 3’ through ‘relay server 2’.

As such, when receiving the answer information for the plurality of questions from the terminals 141, 142, and 143 of ‘member 1, member 2, and member 3’ is completed, the answer transmission unit 114 may transmit the answer information received from the terminals 141, 142, and 143 of ‘member 1, member 2, and member 3’ to the terminal 130 of the manager.

That is, the research managing server 110 according to the present invention may dispersedly receive the answer information from the terminal of each member through a relay server corresponding to a region currently accessed by the terminal of each member in order to disperse traffic of a server in the process of receiving answer information for the research from terminals of members located in various regions.

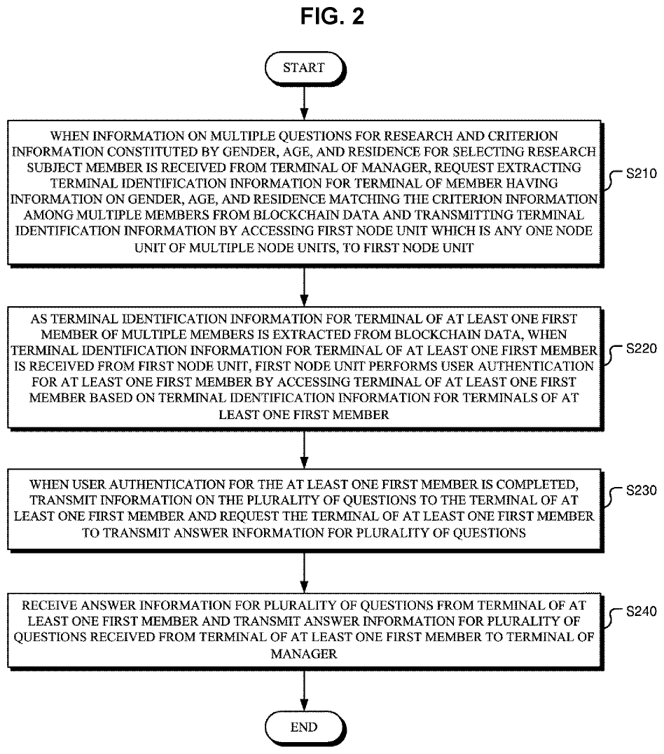

FIG. 2 is a flowchart showing an operating method of a research managing server performing a realtime research interworking multiple node units (each of the plurality of node units stores blockchain data having information on gender, age, and residence of a plurality of members, and terminal identification information for a terminal possessed by each of the plurality of members recorded therein) constituting a blockchain network according to an embodiment of the present invention.

In step S210, when information on multiple questions for the research and criterion information constituted by gender, age, and residence for selecting a research subject member are received from a terminal of the manager, extracting terminal identification information for a terminal of a member having information on gender, age, and residence matching the criterion information among the multiple members from the blockchain data and transmitting the terminal identification information to a first node unit by accessing the first node unit which is any one node unit of multiple node units.

In S220, as terminal identification information for terminals of at least one first member of the multiple members is extracted from the blockchain data, when the terminal identification information for the terminal of at least one first member is received from the first node unit, the first node unit performs a user authentication for the at least one first member by accessing the terminal of at least one first member based on the terminal identification information for the terminals of at least one first member.

In step S230, when the user authentication for the at least one first member is completed, transmitting information on the plurality of questions to the terminal of at least one first member and requesting the terminal of at least one first member to transmit answer information for the plurality of questions are requested.

In step S240, when the answer information for the plurality of questions is received from the terminal of the at least one first member and the answer information for the plurality of questions received from the terminal of the at least one first member is transmitted to the terminal of the manager.

In this case, according to an embodiment of the present invention, step S220 may include maintaining a hash function storage unit storing n (n is a natural number of 2 or more) hash functions (different integer values of 0 to n−1 are allocated to the n hash functions, respectively) previously shared with the terminals of the plurality of members, when the terminal identification information for the terminal for the at least one first member is received from the first node unit, generating an authentication event for performing a user authentication for the at least one first member after accessing the terminal of the at least one first member based on the terminal identification information for the terminal of the at least one first member, when the authentication event is generated, calculating a first operation value by performing a modulo operation having n as a divisor for a date value of a current time when the authentication event is generated, when the first operation value is calculated, extracting a first hash function in which the first operation value is allocated as an integer value among the n hash functions from the hash function storage unit, generating a hash value corresponding each of the at least one first member by applying each terminal identification information for the terminal of the at least one first member to the first hash function as an input, when the hash value corresponding to each of the at least one first member is generated, transmitting the hash value corresponding to each member to each terminal of the at least one first member and transmitting a verification request for the hash value, and as verification for the hash value is completed in response to the verification request in the terminal of the at least one first member, when a verification completion message for the hash value is received from the terminal of the at least one first member, processing completion of the user authentication for the at least one first member.

In this case, according to an embodiment of the present invention, each terminal of the at least one first member may prestore the n hash functions on a memory, when receiving the verification request together with the hash value corresponding to each member from the research managing server, calculate the first operation value by performing a modulo operation having n as the divisor for the date value of the current time when the hash value is received, select the first hash function in which the first operation value is allocated as the integer value among the n hash functions, generate a verification hash value by applying the terminal identification information for the terminal of each member to the first hash function as the input, and then when it is identified that the verification hash value matches the hash value, generate the verification completion message and transmit the generated verification completion message to the research managing server.

Further, according to an embodiment of the present invention, step S230 may include storing and maintaining a server table having server identification information for each of a plurality of relay servers and predetermined regional information corresponding to each of the plurality of relay servers recorded therein, when a user authentication for the at least one first member is completed, identifying a network access region accessed by each terminal of the at least one first member, allocating a relay server having the regional information corresponding to the network access region accessed by the terminal of each member, to each terminal of the at least one first member by referring to the server table one by one, and when the relay server is allocated to each terminal of the at least one first member, transmitting the information on the plurality of questions and the server identification information for the relay server allocated to the terminal of each member to the terminal of the at least one first member and requesting the terminal of at least one first member to transmit the answer information for the plurality of questions through the relay server allocated to the terminal of each member.

In this case, according to an embodiment of the present invention, when the answer information for the plurality of questions is input by the users of the terminals of each member after the information on the plurality of questions is received from the research managing server, each of the terminals of at least one first member may transmit the answer information for the plurality of questions to the research managing server through the relay servers allocated to the terminals of each member among the plurality of relay servers based on the server identification information of the relay servers allocated to the terminals of each member, which is received from the research managing server.

In this case, step S240 may include receiving the answer information for the plurality of questions transmitted from the terminal of the at least one first member through the relay server allocated to each terminal of the at least one first member among the plurality of relay servers.

Hereinabove, referring to FIG. 2, the operating method of the research managing server performing the realtime research according to an embodiment of the present invention has been described. Here, since the operating method of the research managing server performing the realtime research according to an embodiment of the present invention may correspond to the configuration of the operation of the research managing server 110 performing the realtime research described by using FIG. 1, a more detailed description thereof will be omitted.

The operating method of the research managing server performing the realtime research according to an embodiment of the present invention may be implemented by a computer program stored in a storage medium for executing the computer program through coupling with a computer.

Further, the operating method of the research managing server performing the realtime research according to an embodiment of the present invention may be implemented in a program command type which may be performed through various computer means and recorded in a computer readable medium. The computer readable medium may include a program command, a data file, a data structure, etc., singly or combinationally. The program command recorded in the medium may be specially designed and configured for the present invention, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present invention has been described by specified matters such as detailed components, and the like and limited embodiments and drawings, but the description is just provided to assist more overall understanding of the present invention and the present invention is not limited to the embodiment and various modifications and changes can be made by those skilled in the art from such a disclosure.

Accordingly, the spirit of the present invention should not be defined only by the described embodiments, and it should be appreciated that claims to be described below and all things which are equivalent to the claims or equivalently modified to the claims are included in the scope of the spirit of the present invention.

1. A research managing server performing a realtime research interworking multiple node units (each of the plurality of node units stores blockchain data having information on gender, age, and residence of a plurality of members, and terminal identification information for a terminal possessed by each of the plurality of members recorded therein) constituting a blockchain network, comprising:
when information on multiple questions for the research and criterion information constituted by gender, age, and residence for selecting a research subject member is received from a terminal of the manager, an information request unit requesting extracting terminal identification information for a terminal of a member having information on gender, age, and residence matching the criterion information among the multiple members from the blockchain data and transmitting the terminal identification information by accessing a first node unit which is any one node unit of multiple node units, to the first node unit;
as the first node unit extracts terminal identification information for terminals of at least one first member of the multiple members from the blockchain data, when the terminal identification information for the terminal of at least one first member is received from the first node unit, an authentication performing unit performing a user authentication for the at least one first member by accessing the terminal of at least one first member based on the terminal identification information for the terminals of at least one first member;
when the user authentication for the at least one first member is completed, an answer request unit transmitting information on the plurality of questions to the terminal of at least one first member and requesting the terminal of at least one first member to transmit answer information for the plurality of questions; and
an answer transmission unit receiving the answer information for the plurality of questions from the terminal of the at least one first member and transmitting the answer information for the plurality of questions received from the terminal of the at least one first member to the terminal of the manager.

2. The research managing server performing a realtime research of claim 1, wherein the authentication performing unit includes
a hash function storage unit storing n (n is a natural number of 2 or more) hash functions (different integer values of 0 to n−1 are allocated to the n hash functions, respectively) previously shared with the terminals of the plurality of members,
when the terminal identification information for the terminal for the at least one first member is received from the first node unit, an event generation unit generating an authentication event for performing a user authentication for the at least one first member after accessing the terminal of the at least one first member based on the terminal identification information for the terminal of the at least one first member,
when the authentication event is generated, a calculation unit calculating a first operation value by performing a modulo operation having n as a divisor for a date value of a current time when the authentication event is generated,
when the first operation value is calculated, an extraction unit extracting a first hash function in which the first operation value is allocated as an integer value among the n hash functions from the hash function storage unit,
a generation unit generating a hash value corresponding to each of the at least one first member by applying each terminal identification information for the terminal of the at least one first member to the first hash function as an input,
when the hash value corresponding to each of the at least one first member is generated, a verification request unit transmitting the hash value corresponding to each member to each terminal of the at least one first member and transmitting a verification request for the hash value, and
as verification for the hash value is completed in response to the verification request in the terminal of the at least one first member, when a verification completion message for the hash value is received from the terminal of the at least one first member, an authentication completion unit processing completion of the user authentication for the at least one first member.

3. The research managing server performing a realtime research of claim 2, wherein each terminal of the at least one first member prestores the n hash functions on a memory, when receiving the verification request together with the hash value corresponding to each member from the research managing server, calculates the first operation value by performing a modulo operation having n as the divisor for the date value of the current time when the hash value is received, selects the first hash function in which the first operation value is allocated as the integer value among the n hash functions, generates a verification hash value by applying the terminal identification information for the terminal of each member to the first hash function as the input, and then when it is identified that the verification hash value matches the hash value, generates the verification completion message and transmits the generated verification completion message to the research managing server.

4. The research managing server performing a realtime research of claim 1, wherein the answer request unit includes
a server table maintenance unit storing and maintaining a server table having server identification information for each of a plurality of relay servers and predetermined regional information corresponding to each of the plurality of relay servers recorded therein,
when the user authentication for the at least one first member is completed, an identification unit identifying a network access region accessed by each terminal of the at least one first member,
an allocation unit allocating a relay server having the regional information corresponding to the network access region accessed by the terminal of each member, to each terminal of the at least one first member by referring to the server table one by one, and
when the relay server is allocated to each terminal of the at least one first member, a transmission request unit transmitting the information on the plurality of questions and the server identification information for the relay server allocated to the terminal of each member to the terminal of at least one first member and requesting the terminal of at least one first member to transmit the answer information for the plurality of questions through the relay servers allocated to the terminal of each member.

5. The research managing server performing a realtime research of claim 4, wherein when the answer information for the plurality of questions is input by the users of the terminals of each member after the information on the plurality of questions is received from the research managing server, each of the terminals of at least one first member transmits the answer information for the plurality of questions to the research managing server through the relay servers allocated to the terminal of each member among the plurality of relay servers based on the server identification information of the relay server allocated to the terminals of each member, which is received from the research managing server, and
the answer transmission unit includes an answer reception unit receiving the answer information for the plurality of questions transmitted from the terminal of the at least one first member through the relay server allocated to each terminal of the at least one first member among the plurality of relay servers.

6. An operation method of a research managing server performing a realtime research interworking multiple node units (each of the plurality of node units stores blockchain data having information on gender, age, and residence of a plurality of members, and terminal identification information for a terminal possessed by each of the plurality of members recorded therein) constituting a blockchain network, comprising:
when information on multiple questions for the research and criterion information constituted by gender, age, and residence for selecting a research subject member is received from a terminal of the manager, requesting extracting terminal identification information for a terminal of a member having information on gender, age, and residence matching the criterion information among the multiple members from the blockchain data and transmitting the terminal identification information by accessing a first node unit which is any one node unit of multiple node units, to the first node unit;
as the first node unit extracts terminal identification information for terminals of at least one first member of the multiple members from the blockchain data, when the terminal identification information for the terminal of at least one first member is received from the first node unit, performing a user authentication for the at least one first member by accessing the terminal of at least one first member based on the terminal identification information for the terminals of at least one first member;
when the user authentication for the at least one first member is completed, transmitting information on the plurality of questions to the terminal of at least one first member and requesting the terminal of at least one first member to transmit answer information for the plurality of questions; and
receiving the answer information for the plurality of questions from the terminal of the at least one first member and transmitting the answer information for the plurality of questions received from the terminal of the at least one first member to the terminal of the manager.

7. The operation method of a research managing server performing a realtime research of claim 6, wherein the performing of the user authentication includes
maintaining a hash function storage unit storing n (n is a natural number of 2 or more) hash functions (different integer values of 0 to n−1 are allocated to the n hash functions, respectively) previously shared with the terminals of the plurality of members,
when the terminal identification information for the terminal for the at least one first member is received from the first node unit, generating an authentication event for performing a user authentication for the at least one first member after accessing the terminal of the at least one first member based on the terminal identification information for the terminal of the at least one first member,
when the authentication event is generated, calculating a first operation value by performing a modulo operation having n as a divisor for a date value of a current time when the authentication event is generated,
when the first operation value is calculated, extracting a first hash function in which the first operation value is allocated as an integer value among the n hash functions from the hash function storage unit,
generating a hash value corresponding to each of the at least one first member by applying each terminal identification information for the terminal of the at least one first member to the first hash function as an input,
when the hash value corresponding to each of the at least one first member is generated, transmitting the hash value corresponding to each member to each terminal of the at least one first member and transmitting a verification request for the hash value, and
as verification for the hash value is completed in response to the verification request in the terminal of the at least one first member, when a verification completion message for the hash value is received from the terminal of the at least one first member, processing completion of the user authentication for the at least one first member.

8. The operation method of a research managing server performing a realtime research of claim 7, wherein each terminal of the at least one first member prestores the n hash functions on a memory, when receiving the verification request together with the hash value corresponding to each member from the research managing server, calculates the first operation value by performing a modulo operation having n as the divisor for the date value of the current time when the hash value is received, selects the first hash function in which the first operation value is allocated as the integer value among the n hash functions, generates a verification hash value by applying the terminal identification information for the terminal of each member to the first hash function as the input, and then when it is identified that the verification hash value matches the hash value, generates the verification completion message and transmits the generated verification completion message to the research managing server.

9. The operation method of a research managing server performing a realtime research of claim 6, wherein the requesting of transmitting the answer information includes
storing and maintaining a server table having server identification information for each of a plurality of relay servers and predetermined regional information corresponding to each of the plurality of relay servers recorded therein,
when the user authentication for the at least one first member is completed, identifying a network access region accessed by each terminal of the at least one first member,
allocating a relay server having the regional information corresponding to the network access region accessed by the terminal of each member, to each member of the at least one first member by referring to the server table one by one, and
when the relay server is allocated to each terminal of the at least one first member, transmitting the information on the plurality of questions and the server identification information for the relay server allocated to the terminal of each member to the terminal of at least one first member and requesting the terminal of at least one first member to transmit the answer information for the plurality of questions through the relay servers allocated to the terminal of each member.

10. The operation method of a research managing server performing a realtime research of claim 9, wherein when the answer information for the plurality of questions is input by the users of the terminals of each member after the information on the plurality of questions is received from the research managing server, each terminal of at least one first member transmits the answer information for the plurality of questions to the research managing server through the relay servers allocated to the terminal of each member among the plurality of relay servers based on the server identification information of the relay servers allocated to the terminals of each member, which is received from the research managing server, and
the transmitting of the answer information to the terminal of the manager includes receiving the answer information for the plurality of questions transmitted from the terminal of the at least one first member through the relay server allocated to each terminal of the at least one first member among the plurality of relay servers.

11. (canceled)

12. (canceled)

13. A non-transitory computer readable recording medium having a program recorded therein for allowing a computer to execute an operation method of a research managing server performing a realtime research interworking multiple node units (each of the plurality of node units stores blockchain data having information on gender, age, and residence of a plurality of members, and terminal identification information for a terminal possessed by each of the plurality of members recorded therein) constituting a blockchain network, comprising:
when information on multiple questions for the research and criterion information constituted by gender, age, and residence for selecting a research subject member is received from a terminal of the manager, requesting extracting terminal identification information for a terminal of a member having information on gender, age, and residence matching the criterion information among the multiple members from the blockchain data and transmitting the terminal identification information by accessing a first node unit which is any one node unit of multiple node units, to the first node unit;
as the first node unit extracts terminal identification information for terminals of at least one first member of the multiple members from the blockchain data, when the terminal identification information for the terminal of at least one first member is received from the first node unit, performing a user authentication for the at least one first member by accessing the terminal of at least one first member based on the terminal identification information for the terminals of at least one first member;
when the user authentication for the at least one first member is completed, transmitting information on the plurality of questions to the terminal of at least one first member and requesting the terminal of at least one first member to transmit answer information for the plurality of questions; and
receiving the answer information for the plurality of questions from the terminal of the at least one first member and transmitting the answer information for the plurality of questions received from the terminal of the at least one first member to the terminal of the manager.
